(19) United States
(12) Patent Application Publication
(10) Pub. No.: US 2012/0084149 A1
(43) Pub. Date: Apr. 5, 2012

(54) METHODS AND SYSTEMS FOR ONLINE ADVERTISING WITH INTERACTIVE TEXT CLOUDS

(76) Inventors: Paolo Gaudiano, Boston, MA (US); Eric Bonabeau, Santa Fe, NM (US); Pablo Funes, Cambridge, MA (US)

(21) Appl. No.: 13/227,569

(22) Filed: Sep. 8, 2011

Related U.S. Application Data
(60) Provisional application No. 61/381,806, filed on Sep. 10, 2010.
(60) Provisional application No. 61/381,751, filed on Sep. 10, 2010.

(51) Int. Cl. G06Q 30/02

(52) U.S. Cl. 705/14.54

(57) ABSTRACT

A computer implemented method for interactive advertising can include displaying on a display a context-specific interactive text cloud containing a plurality of displayed topics that are topically associated with a common context. An advertisement can be displayed that is topically associated with one or more displayed topics of the plurality of displayed topics, with the common context of the context-specific interactive text cloud, or both. The step of displaying an advertisement can be initiated by an interaction by a user with a first displayed topic of the plurality of displayed topics.

### RELATED APPLICATIONS

This application claims priority to, and the benefit of, co-pending U.S. Provisional Application 61/381,806, filed Sep. 10, 2010, for all subject matter common to both applications. This application also claims priority to, and the benefit of, co-pending U.S. Provisional Application 61/381,751, filed Sep. 10, 2010, for all subject matter common to both applications. The disclosures of said provisional applications are hereby incorporated herein by reference in their entirety.

### FIELD OF THE INVENTION

The disclosed methods and systems relate to delivering advertising, and more specifically relate to advertisements presented on digital media using interactive text clouds.

### BACKGROUND OF THE INVENTION

The delivery of advertising on digital media (such as web sites, blogs, wikis, portals and the like) typically falls in three broad categories: (1) display advertising, which includes showing a graphical or video advertisement alongside with some text content; (2) search advertising, which includes associating advertisements with specific keywords used as queries in online searches; and (3) contextual advertising, which includes tagging specific words or sentences within some online content, and creating a hyperlink between the tagged content and the online advertising.

Display advertising is generally designed to work in a manner similar to advertising on traditional media: a piece of advertising creative, typically an image or video, is presented alongside some content on a web page. The more people see it, the more likely they are to remember a product, or choose to purchase it. The efficacy of display advertising is typically measured through performance metrics such as impressions and click-through rates, the former referring to the number of times a particular piece of advertising is shown on the digital medium, the latter referring to the ratio between the number of times someone actually clicks on the advertisement, and the number of impressions.

Search advertising takes advantage of a common behavior of online users, namely, executing a search query to find some information online. When a user performs an online search, advertisements can be delivered by returning certain links as part of the search results, or by displaying additional links to advertisements alongside the main search results. Search advertising tends to outperform display advertising because the advertising content is related to the topics being searched by the user. Hence search advertising provides a degree of targeting that is difficult to achieve with display advertising. Furthermore, with search advertising, the user is presumably engaged in the search, and is thus more likely to pay attention to the resulting advertisement.

In general, display advertising generates very poor click-through rates, and is often seen as a distraction by users. Targeting is very difficult and is often based on high-level content on a given site, rather than on specific interests of users. While search advertising is more targeted, it can be used only when a user to be actively performing a search.

Contextual advertising, which has emerged more recently as an alternative to display and search advertising, comprises tagging certain portions of a web page, such as a keyword within an article, and creating a link to a pop-up ad or other forms of advertising related to that word. This form of advertising is a hybrid of display and search advertising in the sense that the advertising is linked to a keyword that is based on the context, rather than on a user-submitted search query. The current state-of-the-art in contextual advertising comprises identifying keywords within web pages and creating hyperlinks to advertisement. Payment for in-text advertising is typically based on click-through rates.

### SUMMARY

The methods and systems in accordance with various embodiments of the present invention combine elements of search and display advertising in a way that engages the user, while providing a focused browsing experience.

Methods and systems in accordance with various embodiments utilize an interactive text cloud to provide the user with a visual representation of keywords or topics, rather than embedding a link in the text itself as presently done in contextual advertising.

In accordance with one or more embodiments, an interactive text cloud is provided to the user through a widget, which shows a representation of the content of interest as a plurality of words or topics. The words or topics can be extracted from more extensive sources of text, such as the content of a web site, a news feed, or generally any type of document or file containing text. The interactive text cloud widget can be displayed on a computing device operated by a user such as a personal computer, a smart phone, a personal digital assistant, or the like. The interactive text cloud widget can be displayed on a web or mobile browser of a personal computer or mobile device, or it can be run as a stand-alone application on a computing device.

In one or more embodiments, the size, color and position of a word or topic in the interactive text cloud can be a reflection of that word or topic's frequency of usage, novelty, or popularity, or of its relationship to other words. Alternatively, words or topics represented in the interactive text cloud can be pre-selected based on their importance or other subjective criteria. For example, the interactive text cloud may contain words or topics indicative of major themes or products on a web site. Additionally, words or topics represented in the interactive text clouds may be the result of a combination of selection methods, including some automated selection and some manual selection methods. In this way, the text cloud can provide a visual synopsis of large bodies of text information, giving the user a quick sense of the likely content of the bodies of text.

In accordance with one or more embodiments, the text cloud is interactive and allows the user to interact with the words, e.g., by selecting some words or topics (for instance by clicking on them), removing some unwanted words or topics, focusing on specific words or topics, changing the number of words or topics displayed, or altering the way in which words or topics are displayed.

Text clouds and widgets that display words or topics representative of some content are sometimes referred to as tag clouds. Text or tag clouds are commonly used for displaying frequently-occurring words or topics within a web page, web site, or other online content. Several companies offer web applications for creating text or tag clouds, including, e.g., TagCloud (www.TagCloud.com), Wordle (www.wordle.net), and TagCrowd (www.tagcrowd.com). Methods for creating tag clouds are publicly disclosed on various sites (e.g., en.wikipedia.org/wiki/Tag_cloud). Typical text/tag clouds are used simply to provide a summary of content, rather than as a vehicle for the delivery of online advertisements. The disclosed methods and systems add a degree of interactivity that makes it possible to deliver advertising in a way that combines the characteristics of display advertising, search advertising, and contextual advertising.

As a user interacts with an interactive text cloud, the user's actions indicate user interest in a way that is similar to a search engine. The user may select a word or topic to find articles or documents in which that word or topic is used. The user may also “focus” on a single word or topic to bring up other words or topics that are directly related to the “focused” word or topic.

The disclosed methods and systems can be utilized to deliver online advertising in response to user actions, such as a user action of browsing content organized in a text cloud. As examples, the advertising can be any one or more of the following: (1) in the form of sponsored links, such as those that are typically returned by search engines; (2) in the form of giving higher placement to specific links; (3) delivered in graphical form, such as an icon or small picture; (4) a way to influence which particular keywords are shown within the interactive text cloud; (5) a brand advertised over the entire interactive text cloud widget (for instance, in the title bar); or any other form of advertising as would be appreciated by one of skill in the art.

The selection of particular advertising/advertisements to be delivered in a text cloud can be managed through existing advertising delivery platforms such as DART and AdStream for display advertising, AdSense and Microsoft adCenter for search advertising, and/or Vibrance and Kontera for contextual in-text advertising. Other methods for delivery or advertising are also possible.

The methods and systems in accordance with various embodiments of the present invention combine benefits of display advertising, search advertising, and contextual advertising. As with typical display advertising, a user is offered relevant advertisements (such as the logo of a company, a link to a web site, or some advertising copy) while the user explores information content of, e.g., an online website. As with search advertising, the user can interact with the content, seeking specific, relevant pieces of information through the selection of keywords (i.e., words or topics in a text cloud), to which advertising can be attached using similar methodology that applies to search advertising. As with contextual advertising, specific words or topics relevant to a body of text can become links to advertising messages that are relevant to the context in which the words or topics appear. The methods and systems in accordance with various embodiments provide improvements over each of these three types of traditional online advertising.

Methods and systems in accordance with various embodiments can provide improvements over display advertising. In traditional display advertising, the user is presented with a banner or other advertising element somewhere along with the content of the online material. The advertising element is not part of the online content, and the user will typically only choose to interact with the advertising element if it happens to catch the user's attention. By contrast, with method and systems in accordance with various embodiments, the user interacts with the interactive text cloud in order to obtain additional information about the online content in which the user is interested, and advertising is displayed in response to the user interaction with the text cloud. Because some embodiments provide that advertisements are displayed in response to the user interacting with specific keywords (i.e., words or topics) of interest, some example interactive text clouds provided herein enable a level of targeting based on the user's indicated interests that is more similar to the targeted advertisements of search advertising.

Methods and systems in accordance with various embodiments of the present invention can also provide improvements over search advertising. In traditional search advertising, the delivery of advertising typically requires the user to be performing an online search; users however are not conducting searches during much of their online browsing activity, e.g., during browsing of information content of a website. By contrast, the disclosed methods and systems of the present invention can deliver keyword-based advertising while the user is interacting with content during such browsing activity. More specifically, certain embodiments allow users to browse content only by interacting with keywords (i.e., words or topics in a text cloud). Accordingly, such embodiments effectively categorize information content of a website or other document/source text into easy-to-use words or topics. This type of interaction-based browsing enables (1) enhanced keyword-based advertising, (2) a more user-friendly browsing environment whereby large quantities of information are conveniently organized into more manageable topics, and (3) a reduction in off-topic, irrelevant (i.e., untargeted) advertisements that tend to reduce overall user satisfaction.

Another advantage of the methods and systems in accordance with various embodiments relative to search advertising is that in search advertising a user typically enters only a small set of keywords per query. By contrast, interactive text clouds according to illustrative embodiments of the present invention present a plurality of keywords (i.e., words or topics), all of which are in some way (e.g., topically) related to the online content that the user is browsing. A user interacting with a broader number of keywords presented in such interactive text clouds is more likely to find and select keywords that are of particular interest.

Methods and systems in accordance with various embodiments of the present invention can also provide improvements over contextual advertising. First, the keywords (i.e., words or topics) selected by contextual advertising typically are simply links to advertising. By contrast, the disclosed methods and systems present a plurality of keywords (i.e., words or topics) with which the user can discover further information and navigate to other portions of information content of one or more documents or source texts. This creates additional motivation for users to interact with the keywords (i.e., words or topics), thereby creating additional opportunity for advertising content. Second, in contextual advertising, the keywords are typically selected by an algorithm, and then become a fixed component of the online content. By contrast, the interactive nature of the disclosed methods and systems allows the user to change the keywords displayed, leading to a more flexible method of delivery, and one that is more closely targeted to the user's interests and that does not overload or bombard users with an burdening amount of off-topic or irrelevant advertisements.

Methods and systems in accordance with various embodiments also provide improvements over other forms of digital advertising because they allow for multiple advertising pricing structures. Typical advertising pricing structures include: Cost Per Mille (CPM), in which advertisers pay for the number of times that a display advertisement is shown on a page visited by a user, is typically used with display advertising units; Cost Per Click (CPC), in which advertisers pay for the number of times a user clicks on their listing (such as a link returned during a search), is typically used with search advertising; and Cost Per Action (CPA) and the related Cost Per Lead (CPL) and Cost Per Engagement (CPE), in which advertisers pay for performance when the user engages with the advertising unit, e.g., clicking an ad to see a video about the advertiser, or filling out a form, is typically used with interactive ad units such as animated ads, games embedded in ad units, or polls. The disclosed methods and systems can deliver advertisements using any or all of these pricing models: advertisers can pay to have their logo or tag line displayed within or alongside the interactive text cloud; they can pay when the user interacts with the text cloud by clicking a word or hovering the cursor over specific words or by selecting a focus word; or they can pay when the user clicks on a link delivered to the user.

In one exemplary embodiment of the present invention, an interactive text cloud widget shows a visual synopsis of the day's world news, aggregated from a wide variety of news sources. Accordingly, the interactive text cloud widget can provide a representation of one document or source text, or can provide a representation of multiple documents or source texts. The widget displays several words or topics (optionally of varying size). Connections can be drawn between one or more of the displayed words or topics. For example, the site of each word or topic can be proportional to how frequently that word or topic occurs in the source text(s). The location of words or topics relative to one another, and the links connecting them, can represent a measure of how closely the words or topics are related (e.g., physically located to one another) within the source text.

For example, let us suppose that on this day the president of the United States of America announced a plan to provide fiscal support to automakers, and that this has received significant press coverage. Within the widget, the words or topics “president” and “automaker” can be presented and may be relatively large in size relative to other words. Furthermore, the words or topics “president” and “automaker” may be connected to one another, e.g., by a line, color association, etc. A user viewing the display presented by the widget can hover a cursor over the word “automaker,” and this can cause a further display of information. For example, a pop-up panel can be presented. The pop-up panel may show a series of links to articles discussing this news item, which can be extracted from one or more of the source texts used to create the text cloud. Furthermore, the pop-up panel may include one or more additional links of the type that would have been presented if the user had performed a search for the keyword “automaker” using a traditional search engine. Accordingly, in such embodiments, the documents or source texts from which the text cloud is generated can include both RSS feeds and results pages of a search engine. Alternatively or additionally, the pop-up panel may contain small graphics from advertisers who wish to be associated with the word “automaker.”

The visualization of these links and graphical advertising elements represent impressions just as with traditional display advertising. However, unlike traditional display advertising, the visualization of the links and graphical advertising elements is initiated at least in part by the browsing user's actions, which suggest a level of interest similar to what occurs during a search. In some example embodiments, the advertisement links included for display can be selected in a similar manner to that currently done for traditional search advertising. However, in such example embodiments, users first must interact with keywords (i.e., words or topics) included in the interactive text cloud to be presented with such advertisements links. And, as with Io display advertising and search advertising, click-through rates can be monitored.

The user interaction with words or topics in interactive text clouds according to further embodiments of the present invention can be used in additional ways. For example, since a user selecting a particular word or topic (and thereby following a content link to a different portion of a site or a different site altogether) is indicative of user interest, the “landing” site to which the user is redirected can include highly targeted advertising, e.g., associated with the particular selected word or topic. Furthermore, the entire interactive text cloud can include a “sponsor” as an additional form of advertising.

The source text used to generate the interactive text cloud can be in a wide variety of formats and be extracted from a wide variety of sources. Non-limiting examples include: keyword searches, RSS feeds, documents from a hard drive or online repository in any readable format (plain text, HTML, XML, PDF, DOC, and so on), Twitter feeds, Facebook wall posts, LinkedIn network updates, Craigslist online classifieds, and many others that will be appreciated by one of skill in the art upon reading, the present specification.

In accordance with one embodiment of the present invention, a computer implemented method for interactive advertising can include displaying on a display a context-specific text cloud containing a plurality of displayed topics that are topically associated with a common context. An advertisement can be displayed that is topically associated with one or more displayed topics of the plurality of displayed topics, with the common context of the context-specific text cloud, or both. The step of displaying an advertisement can be initiated by an interaction by a user with a first displayed topic of the plurality of displayed topics.

In accordance with further embodiments of the present invention, the interaction with the first displayed topic of the plurality of displayed topics by the user can result in displaying information content of a document or source text from which one or more of the plurality of displayed topics are derived. The plurality of displayed topics can be derived from, and topically associated with, information content of a document or source text. The document or source text can include a website or a text file containing a feed. The context-specific text cloud can be generated at least in part from one or more documents or source texts.

In accordance with yet further embodiments of the present invention, the advertisement can be presented as a link, as a logo, in a graphical form, in a textual form, or a combination thereof. The advertisement can be displayed in conjunction with one or more links associated with the first displayed topic. The advertisement can be displayed in a pop-up panel or in a separate existing panel. The first displayed topic can include one of the one or more topics with which the advertisement is topically associated. The advertisement can be topically associated with one or more of the plurality of displayed topics. The advertisement can be topically associated with all of the plurality of displayed topics. The advertisement can be topically associated with the common context of the context-specific text cloud. The advertisement can be topically associated with one or more tags that are associated with the context-specific text cloud. The advertisement can be automatically selected to be topically associated with the one or more displayed topics of the plurality of displayed topics, with the context-specific text cloud, or both. The advertisement can be manually selected to be topically associated with the one or more displayed topics of the plurality of displayed topics, with the context-specific text cloud, or both.

In accordance with yet further embodiments of the present invention, a pop-up panel can be displayed that includes one or more links associated with the first displayed topic, and the advertisement can be presented as one of the one or more links. A pop-up panel can be displayed that has one or more links associated with the first displayed topic, and the pop-up panel further can include the advertisement. The interaction by the user with the first displayed topic can include the user clicking, hovering over, or selecting the first displayed topic.

In accordance with another embodiment of the present invention, a machine readable storage medium contains executable instructions stored thereon, and execution of the instructions can cause a computing device to execute a method. The method can include displaying on a display a context-specific text cloud containing a plurality of displayed topics that are topically associated with a common context. An advertisement can be displayed that is topically associated with one or more displayed topics of the plurality of displayed topics, with the common context of the context-specific text cloud, or both. The step of displaying an advertisement can be initiated by an interaction by a user with a first displayed topic of the plurality of displayed topics.

In accordance with further embodiments of the present invention, the interaction with the first displayed topic of the plurality of displayed topics by the user can result in displaying information content of a document or source text from which one or more of the plurality of displayed topics are derived. The plurality of displayed topics can be derived from, and topically associated with, information content of a document or source text. The context-specific text cloud can be generated at least in part from one or more documents or source texts. The advertisement can be displayed in conjunction with one or more links associated with the first displayed topic. The first displayed topic can include one of the one or more topics with which the advertisement is topically associated.

In accordance with another embodiment of the present invention, a computer implemented system can include an advertisement engine for receiving a plurality of advertisements. A text cloud generator can be included that is configured to generate a context-specific text cloud. The context-specific text cloud can include a plurality of topics that are topically associated with a common context, and an advertisement of the plurality of advertisements. The advertisement can be topically associated with one or more of the plurality of topics, with the common context of the context-specific text cloud, or both. The system further can include a client communications module for causing some or all of the context-specific text cloud to be displayed on a user device. The advertisement can be configured to be displayed as a result of an interaction by a user with a first topic of the plurality of topics.

In accordance with further embodiments of the present invention, the plurality of topics can be derived from, and topically associated with, information content of a document or source text. The context-specific text cloud can be generated at least in part from one or more documents or source texts. The advertisement can be caused to be displayed in conjunction with one or more links associated with the first topic. The first topic can include one of the one or more topics with which the advertisement is topically associated.

### BRIEF DESCRIPTION OF THE FIGURES

These and other characteristics of the present invention will be more fully understood by reference to the following detailed description in conjunction with the attached drawings, in which:

FIG. 1A is an illustrative diagram of an example interactive text cloud according to embodiments of the present invention;

FIG. 1B is an illustrative diagram of the example interactive text cloud of FIG. 1A, and depicting a further display of information, according to aspects of the present invention;

FIG. 1C is an illustrative diagram of the example interactive text cloud of FIG. 1A, subsequent to an action by a user of removing one of the displayed words or topics, according to further aspects of the present invention;

FIG. 1D is an illustrative diagram of the example interactive text cloud of FIG. 1C, subsequent to an action by a user of focusing on one of the displayed words or topics, according to further aspects of the present invention;

FIG. 2A is an illustrative diagram of a plurality of example interactive text clouds overlayed on a website, according to further embodiments of the present invention;

FIG. 2B is an illustrative diagram of the plurality of example interactive text clouds of FIG. 2A, and depicting a further display of information, according to further aspects of the present invention;

FIG. 3A is an illustrative diagram of a search results web page;

FIG. 3B is an illustrative diagram of a text cloud generated at least in part from the search results web page of FIG. 3A, according to further embodiments of the present invention;

FIG. 3C is an illustrative diagram of the example interactive text cloud of FIG. 3B, and depicting a further display of information, according to further aspects of the present invention;

FIG. 4 is an illustrative diagram of an example system for implementing the functionality of the disclosed embodiments, according to further aspects of the present invention;

FIG. 5 is an illustrative diagram of an example method for generating an interactive display of a text cloud, according to further aspects of the present invention; and

FIG. 6 is an illustrative diagram of an example computing system for implementing the example system of FIG. 4, according to one aspect of the present invention.

### DETAILED DESCRIPTION

An illustrative embodiment of the present invention relates to the delivery of advertising through online digital media as a user navigates through interactive text clouds. The advertising can be delivered to a wide range of computing devices operated by users including, but not limited to, computers, smartphones, cellular phones, and personal digital assistants. The computing devices can access the online digital media over a communications network such as the Internet, an intranet, a cellular network, or other communication channel. In some embodiments, the advertising is delivered to users from a server system hosting a website providing the digital media and interactive text clouds. The server system may comprise one or more physical machines, or virtual machines running on one or more physical machines. In addition, the server system may comprise a cluster of computers or numerous distributed computers that are connected by a network such as the Internet.

Interactive text clouds provide a way to combine the benefits of online display advertising and search advertising by providing the user with content of interest to them, and evincing from the user's actions the user's topics of interest, which can be leveraged to provide targeted advertising.

Interactive text clouds can have a variety of appearances, including size, color, shape and position of the widget itself, as well as size, color, number and position of words within the widget. They can be implemented through a variety of available computer software systems, and can be deployed on generally any online digital asset. Examples of digital assets include, but are not limited to, web sites, blogs, wikis, portals, and the like. As discussed above examples of applications for generating text clouds include, but are not limited to, TagCloud (www.TagCloud.com), Wordle (www.wordle.net), and TagCrowd (www.tagcrowd.com). Methods for creating tag clouds are publicly disclosed on various sites (e.g., en.wikipedia.org/wiki/Tag_cloud).

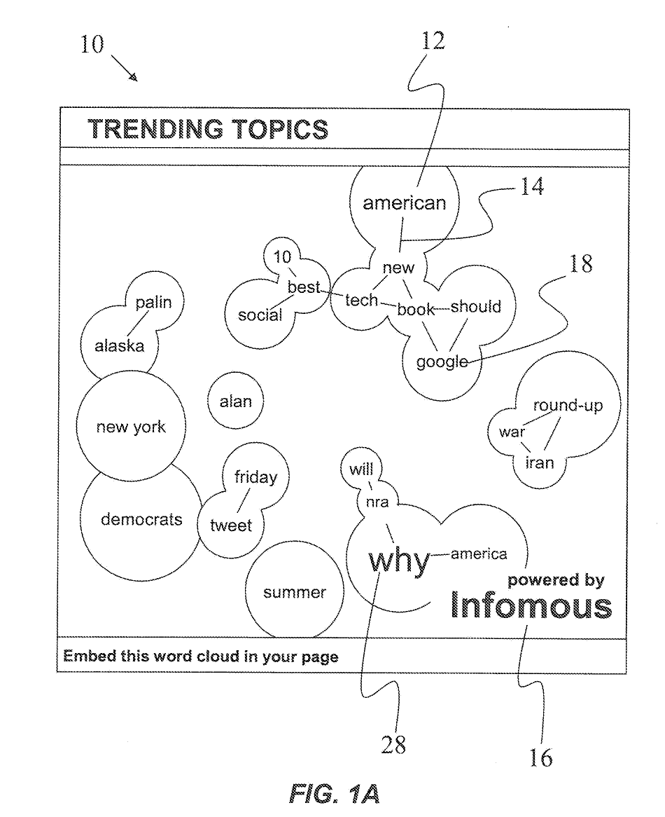

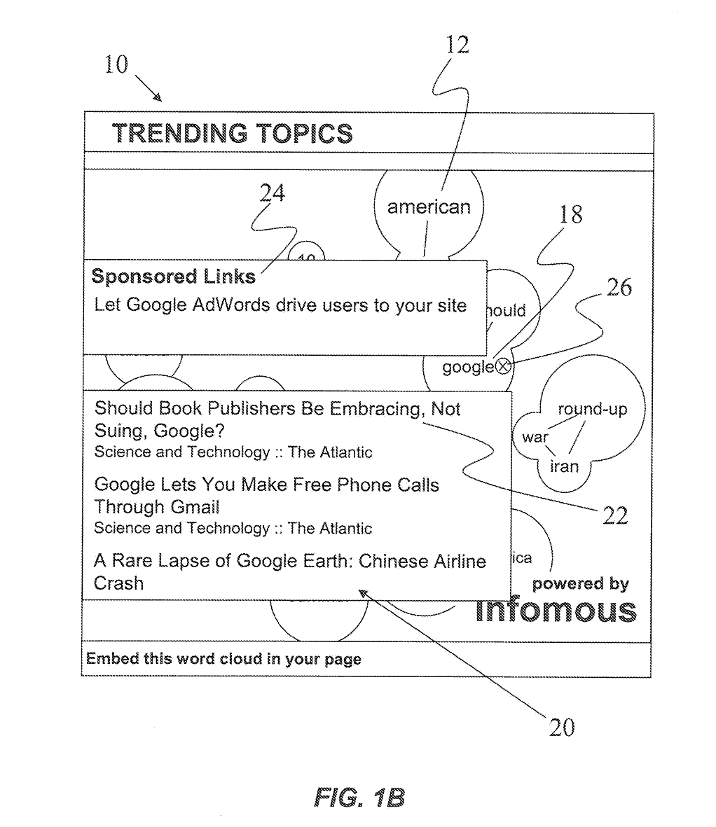

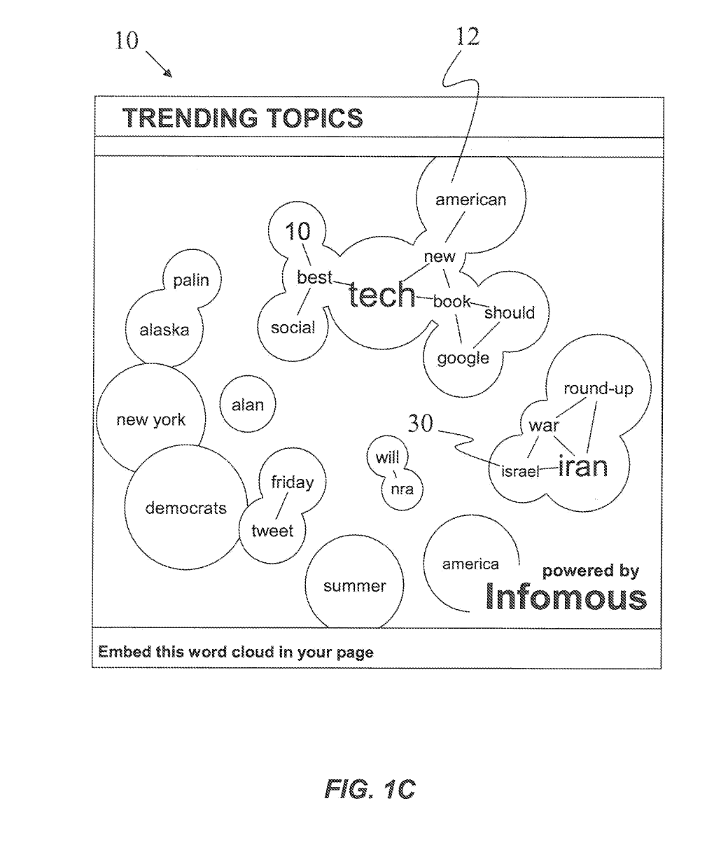

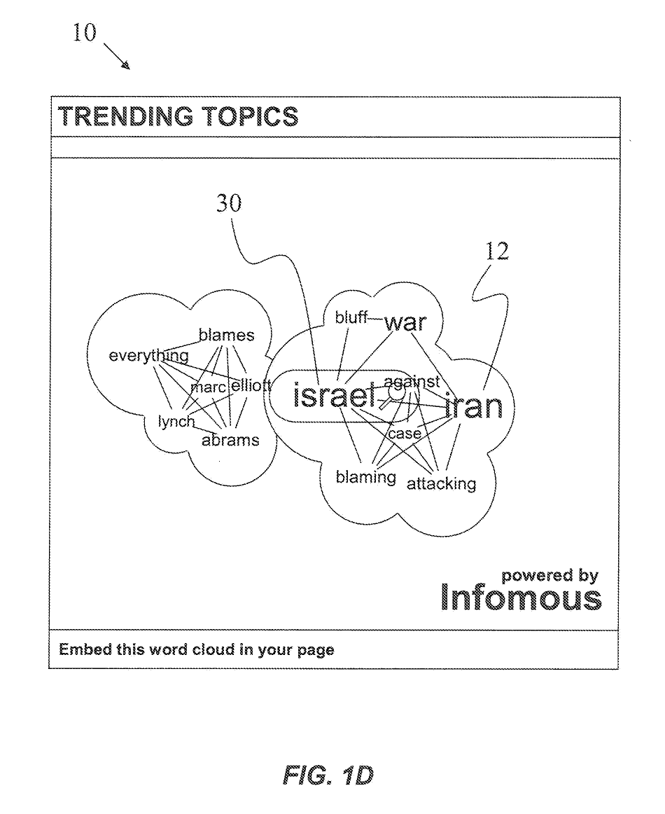

FIGS. 1A through 6, wherein like parts are designated by like reference numerals throughout, illustrate example embodiments of an exemplary widget that can display interactive text clouds to users, according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1A depicts an example interactive text cloud 10 displayed by a widget, according to embodiments of the present invention. The example interactive text cloud includes twenty four words or topics 12, e.g., which have been extracted from a variety of source text(s) in a format known as RSS feed. An RSS feed comprises a text file containing some headings and descriptive labels to facilitate display of the text for an end user. In the example interactive text cloud 10 of FIG. 1A, the words or topics 12 represent a selection of the most-frequently occurring words in the collection of RSS feeds that contain information about daily news from a magazine website on a particular date. The size of each word or topics 12 is indicative of its frequency relative to the frequency of other words or topics 12. The location of words or topics 12 relative to one another, as well as the thin lines 14 connecting some words or topics 12, is indicative of the fact that certain words or topics 12 tend to occur in close proximity to one another in the source text(s).

In the example embodiment of FIG. 1A, the widget initially displays the example text cloud 10. The example text cloud 10 can be displayed to a user, e.g., in conjunction with or as an overlay on top of a website contemporaneously being accessed by the user through the user's browser client. The display of the interactive text cloud 10 further can include a logo 16 (the “Infomous” logo in this example), e.g., as an overlay on the displayed interactive text cloud 10. The logo 16 represents display advertising that can be provided by the widget. However, the widget also demonstrates characteristics typical of contextual advertising, since each word or topic 12 can be related to the information content of the website contemporaneously being viewed by the user and further can “link” to one or more advertisements displays (e.g., can result in a further display of information that includes an advertisement). Furthermore, the example embodiment of FIG. 1A also incorporates the benefits of search advertising through the use of novel display features. In particular, and as illustrated in FIG. 1B, the user hovering a cursor over a word or topic 12 (the word or topic “google” 18 in the depicted example) or clicking that word or topic 12 causes a pop-up panel 20 to be displayed, which includes a series of links 22. Each such link can be a hyperlink that is included in the web page currently being viewed by the user or contained in another source text from which the interactive text cloud 10 was generated. Furthermore, each of the links 22 is presented in the pop-up panel 20 resulting from user interaction with the word or topic “google” 18 because each of the links 22 contains the word “google.” Each link 22 can refer to a website, a document, a news article, or any other source text or portion thereof. Thus, by clicking one of the links 22, the user may navigate to a website, etc. containing the source text. Furthermore, upon navigating to the website containing source text of one of the links 22, traditional display advertising or further interactive text clouds can be displayed to the user. As also depicted in FIG. 1B, the pop-up panel 20 also can include sponsored links 24. Since the word or topic “google” 18 has been selected by the user, a sponsored link advertising Google AdWords can be displayed. For example, the AdWords can be received from a remote ad server. Furthermore, by selecting (e.g., hovering a mouse over, clicking, etc.) a word or topic 12, the user is likely seeking information relative to that word or topic 12, which can provide an opportunity for targeted advertising.

The user can further interact with the interactive text cloud 10 to remove unwanted words or topics 12 from the display, e.g., by clicking on an “X” 26 that is displayed to the right of (or otherwise in conjunction with) each word or topic 12. For example, the “X” 26 can be displayed any time the user clicks on or hovers over a word or topic 12. In some embodiments, removing one word or topic 12 in this fashion can prevent the removed word or topic 12 from being shown again to the user by the widget. Furthermore, such removal of a word or topic 12 can result in another frequently occurring word or topic 12 being added by the widget to the interactive text cloud 10, e.g., so as to retain a same total number of words or topics 12 being displayed. FIG. 1C to depicts the interactive text cloud 10 of FIG. 1A subsequent to a user removing a word or topic “why” 28. Accordingly, in the example embodiment of FIG. 1C, removal of the word or topic “why” 28 results in addition of a word or topic “Israel” 30. In this way, the interactive text cloud 10 provides users with an ability to remove displayed words or topics 12 that are not of interest, thereby increase the relevance of delivered advertisements.

The user can further interact with the interactive text cloud 10, e.g., by causing one or more words or topics to become a “focus” of the interactive text cloud 10. In the example shown in FIG. 1D, the user has focused on the word or topic “Israel” 30, e.g., by clicking on it. The word or topic “Israel” 30 is consequently highlighted and positioned near a center of the interactive text cloud 10, such that other words or topics 12 surround it in clusters. Accordingly, the words or topics 12 surrounding a focused word or topic, such as the word or topic “Israel” 30, represent themes and concepts related to the focused word or topic. This, too, further increases the relevance of the displayed words or topics 12 to a user browsing the content, thereby offering even greater targeting opportunities for the delivery of advertisements.

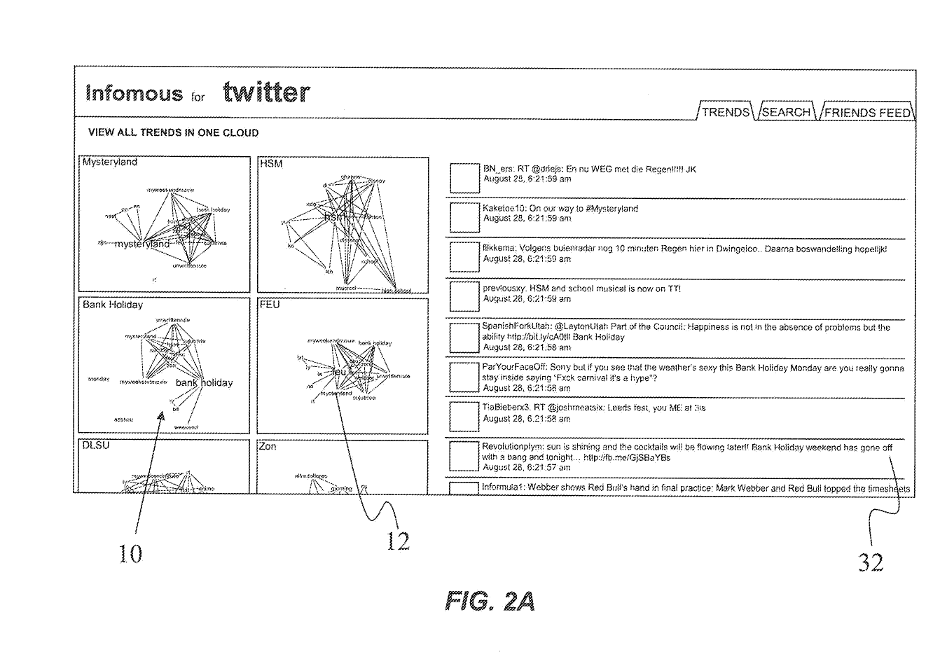

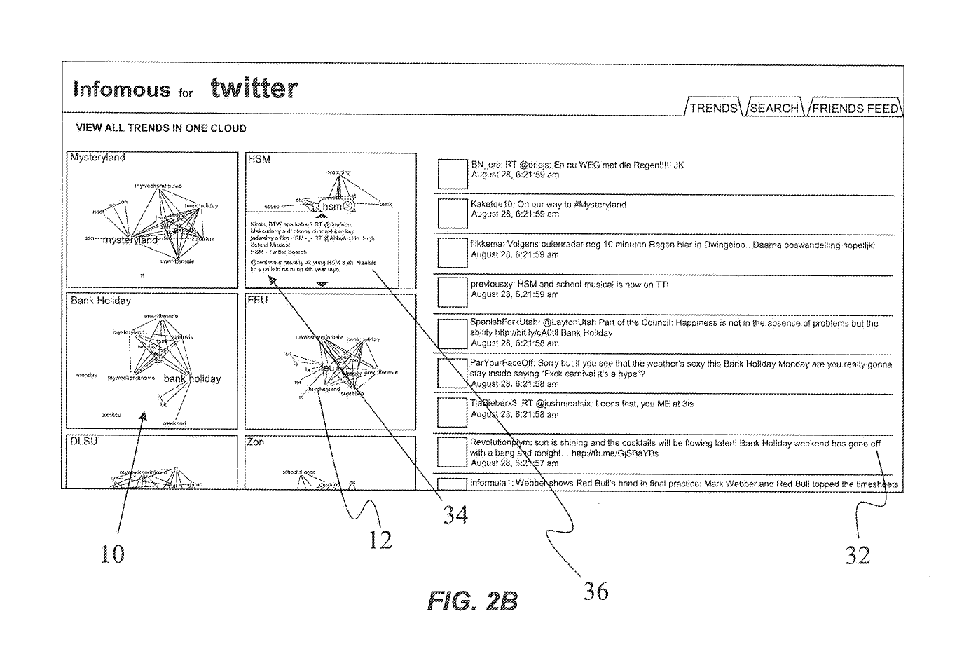

In an exemplary embodiments depicted in FIGS. 2A and 2B, a plurality of interactive text clouds 10 are displayed on a web page 32 accessed by a user. In this example, each interactive text cloud 10 summarizes relevant to a particular term found on a Twitter social site. The particular Twitter terms used to generate the interactive text clouds 10 are those commonly referred to as “trends” corresponding roughly to the most frequently occurring terms currently found on Twitter posts. The user can interact with each interactive text cloud 10 in the same way as described with respect to the embodiment of FIGS. 1A through 1C. For example, as shown in FIG. 2B, the user selecting one of the words or topics 12 results in a further display of information, such as a pop-up panel 34 that includes a list of “Tweets” 36 containing the selected word or topic 12. The pop-up panel 34 can be enhanced to include sponsored links, logos, or other forms of advertising. The user selecting one of the “Tweets” 36 results in the user's browser client being redirected to the selected Tweet, and/or delivery of additional advertising content.

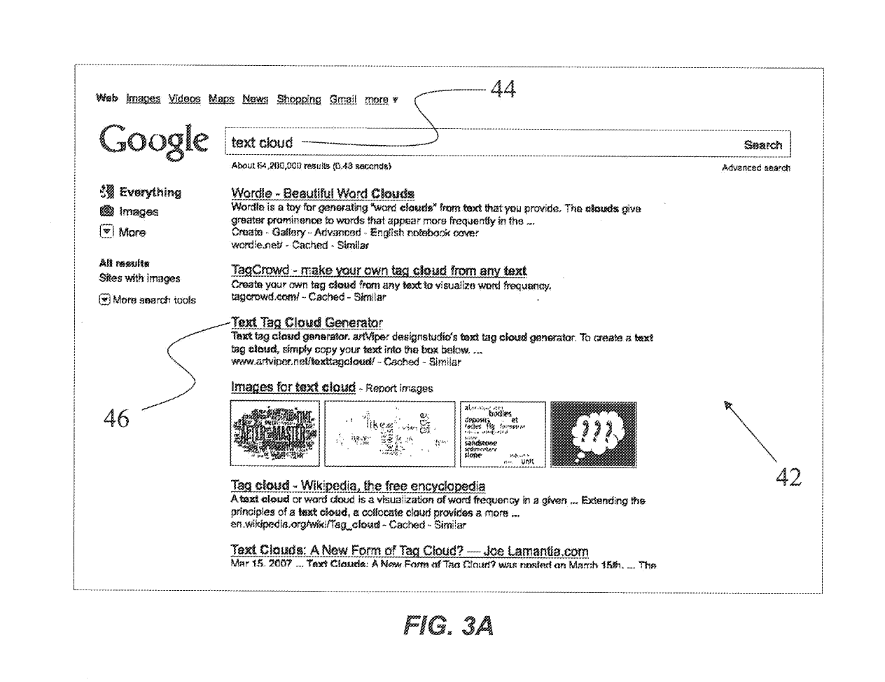

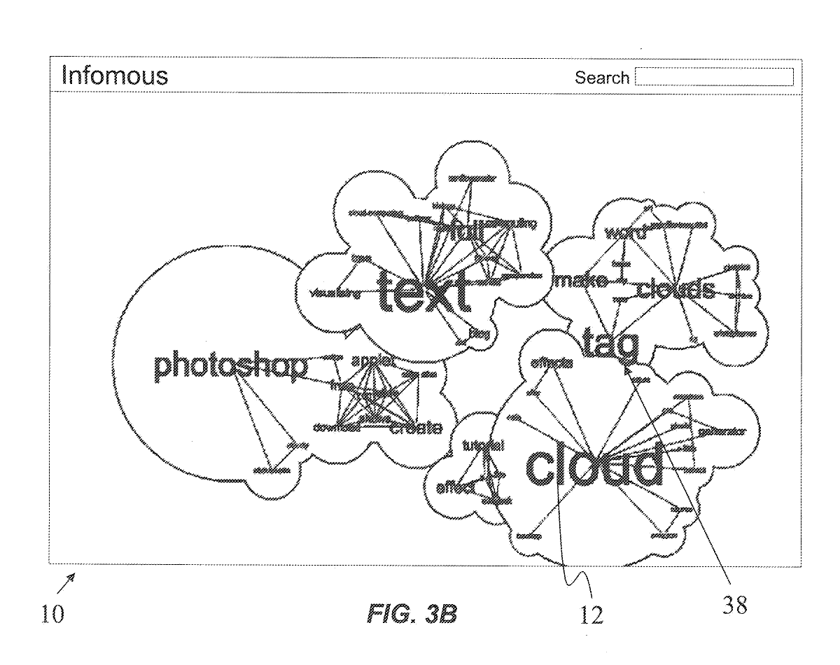

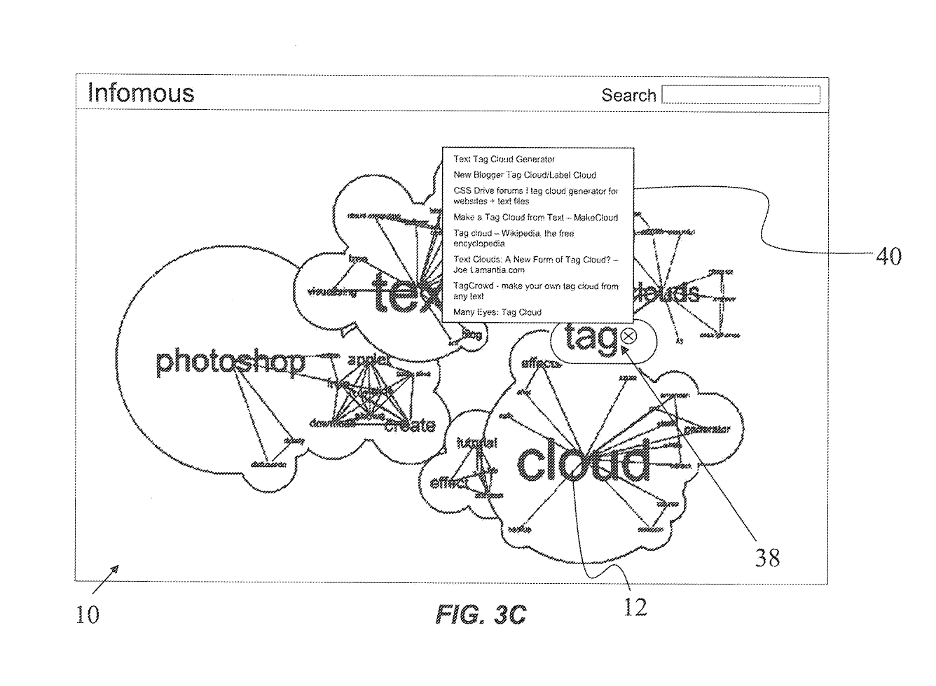

FIGS. 3A through 3C illustrate yet another exemplary interactive text cloud 10 in accordance with an example embodiment of the present invention. Specifically, FIG. 3A depicts a Google search results web page 42 defined by a user query 44 including query terms, “text” and “cloud.” FIG. 3B depicts an interactive text cloud 10 contains words or topics 12 generated at least in part from the search results web page 42 of FIG. 3A. In particular, the words or topics 12 of FIG. 3B can be derived from information content of the search results website of FIG. 3A. For instance, the words or topics 12 can be extracted from the various search results 46 depicted in FIG. 3A. The interactive text cloud 10 of FIG. 3B thus provides the user with a quick visual overview of the search results that can be interactively explored through browsing actions. FIG. 3C further depicts that, by clicking on or hovering a cursor over a word or topic “tag” 38, a plurality of links 40 are displayed. Each of the plurality of links 40 are based on information content of the source text, e.g., is based on the various search results 46 of the search results website 44. Furthermore, the links 40 associated with the word or topic “tag” 38 can include only those search results from the search results website of FIG. 3A that contain the word “tag.”

The sponsored links that are normally returned through a search executed on Google, Bing or other search engines can be included in the pop-up panels of embodiments described and depicted herein. Alternatively or additionally, advertisers can pay to have particular words (e.g., “Ford”) displayed as an overlay on an interactive text cloud, as one of the words or topics making up the interactive text cloud, or otherwise in conjunction with the interactive text cloud. For example, when a user searches for the keyword “automotive,” the widget can display a text cloud having a plurality words or topics, one of which is the word “Toyota” (e.g., as plain text, as stylized text, as a logo, etc.), while simultaneously excluding words or topics representing competitors. Finally, advertisements (e.g., a company name or logo, etc.) can be included in a frame that surrounds the interactive text cloud. Advertisements contained in the frame can be linked to particular source texts, contexts, etc., and thus can change depending on the particular search performed by the user, website being viewed by the user, etc.

In accordance with one or more further embodiments, interactive text clouds according to embodiments of the present invention can be used to navigate a website or portal. The words or topics displayed in such interactive text clouds can be extracted automatically from information content of one or more web pages of a website or portal, e.g., of a website currently being accessed by a user. Alternately, the displayed words or topics can be selected manually (e.g., by the user, by a system administrator, etc.) to represent keywords or topics most indicative of the information content of the website or portal. When the user hovers a cursor over (or otherwise selects or interacts with) a word or topic, a pop-up panel can be displayed, which can include a list of links. One or more of the links can be configured to redirect the user's browser client to other websites or portions thereof where particular related information content is contained. Furthermore, one or more of the links can be derived from links contained within the information content of the website currently being accessed. As yet further possibilities, one or more of the links can link to other web pages that make up the website or portal but are not currently being viewed by a user. For instance, if a user is viewing a first web page about a particular model of Toyota cars, one or more of the links contained in one or more of the pop-up panels of an interactive text cloud presented in conjunction with the first web page can include links to other web pages on Toyota's website advertising different models of cars. In some embodiments, the pop-up panel associated with a particular word or topic can also include an additional list or plurality of links, similar to the types of sponsored links that would be generated through search advertising if a user had entered the selected word or topic into a search engine.

The techniques for generating interactive text clouds and delivering advertising described above are preferably implemented by a computer, and accordingly one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD or DVD ROM), a removable storage device (e.g., external hard drive, memory card, or flash drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Accordingly, embodiments of the present invention can allow users to utilize the described widgets and interactive text clouds to access and browse information content of interest to the user. The browsing actions by which the user explores the information content of interest farther can initiate presentation of one or more advertisements related to the information content in which the user has chosen to further explore.

While the display features are described and depicted herein with reference to widgets operating in conjunction with interne browser clients, it can be appreciated by one of skill in the art that there are many other ways to implement and present interactive text clouds according to embodiments of the present invention. For example, the widget alternatively can be implemented as a tool bar, a plug-in, a smart phone “app,” a stand-alone application, or can operate in conjunction with any other user client device. The widget can be accessible to users via any suitable type of computing device, including, as illustrative examples, personal computers, laptops, handheld devices, mobile devices, smart phone devices, wireless devices, tablet computers, and other computing devices. Furthermore, the methods can be executed by a wide variety of computer implemented systems, as would be appreciated by one of skill in the art.

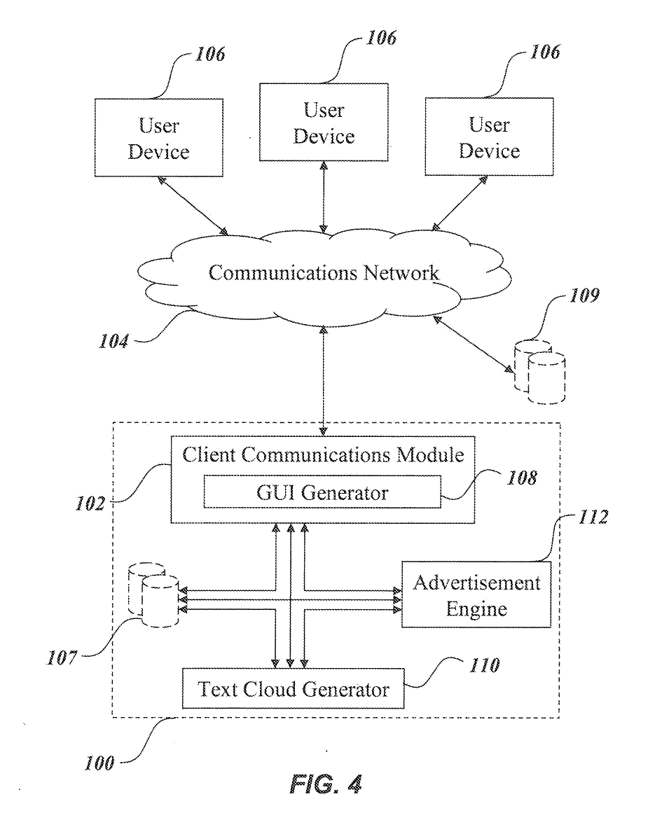

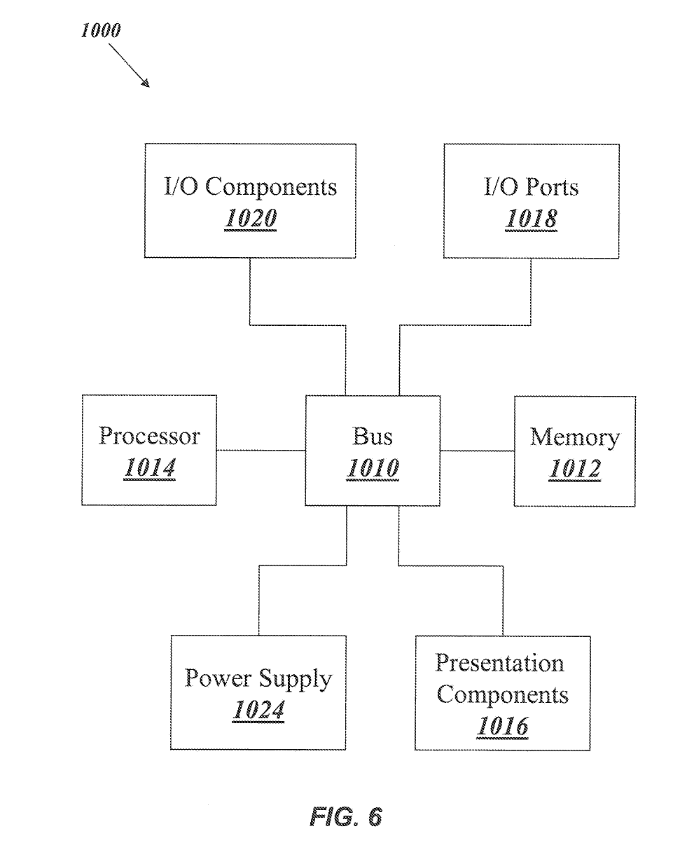

For example, FIG. 4 depicts one exemplary computer implemented system 100 for providing the features and functions described herein. The example system 100 can be implemented by a wide variety of suitable computing environments, including, for example, the computing environment depicted in FIG. 6. The example system 100 can include a client communications module 102 for connecting to a communications network 104, thereby enabling one or more users operating user devices 106 to interact with and engage the functionality and interactive text clouds described herein. The client communications module 102 can include a graphical user interface (GUI) generator 108, which can generate one or more GUI's comprising various displays of information. For example, the displays of information can include interactive text clouds, such as any one or more of the example interactive text clouds of FIGS. 1A through 3C. The system 100 optionally can include one or more local databases 107 for storing data created, received, and/or transmitted by the system 100. Alternatively or additionally, the system 100 can connect to and store data in one or more remote databases 109. For example, the remote databases 109 can be in “the cloud,” e.g., hosted or otherwise provided by a cloud data storage provider.

The system 100 additionally can include a text cloud generator 112 for generating the interactive text clouds according to embodiments of the present invention. The system 100 farther can include an advertisement engine 112 for receiving one or more advertisements to be included in text clouds generated by the text cloud generated 110. For example, the advertisement engine 112 can communicate over the communications network 104 with an advertisement server hosted by a third-party ad service provider (not shown). The advertisement engine 112 and the text cloud generator 110 can be configured to communicate with the local databases 107, the remote databases 109, the client communications module 102, and/or with each other.

The user device 106 can include any suitable computing device, as previously described herein. As further non-limiting examples, the user device 106 can include any one or more of the following: “laptop,” a “desktop,” a “hand-held device,” a “mobile device,” a “smart phone,” a “tablet computer.” a “portable transceiver,” a “set-top box” (e.g., for internet TV), and any other suitable computing device, as would be understood by one of skill in the art. As such, some or all of the features, components, and functions of the system 100 (including the particular implementation and/or graphic display of the text clouds) can be customized to accommodate different and/or multiple types of user devices 106 with which the system 100 is configured to communicate.

For purposes of illustration, the example system 100 is simplified and depicts the various modules and components as discrete blocks. However, one of skill in the art can appreciate that in actuality the lines of the modules and other components of FIG. 4 may not always be well defined; rather, in some instances multiple of the modules and components depicted in FIG. 4 can act as a single unit. In general, the modules, generators, engines, and other components depicted in FIG. 4 can be implemented as executable instructions stored on one or more computer readable storage media and configured to perform, upon execution, the various methods and processes described herein, e.g., with reference to the interactive text clouds. One of skill in the art will appreciate a number of ways to merge together or split apart the modules and components of FIG. 4, depending on the intended applications, the particular computing environment, the particular programming language, and the like.

Furthermore, in some embodiments, a module or component represented by only one block actually is implemented with multiple such modules or components. In some instances, modules or components depicted as being included in the system 100 can instead be excluded from the system 100, and modules or components depicted as not being included in the system 100 alternatively can be incorporated therein. One of skill in the art will readily appreciate a variety of ways to expand, reduce, or alter the example system 100. All such alterations and embodiments are contemplated within the scope of the present invention.

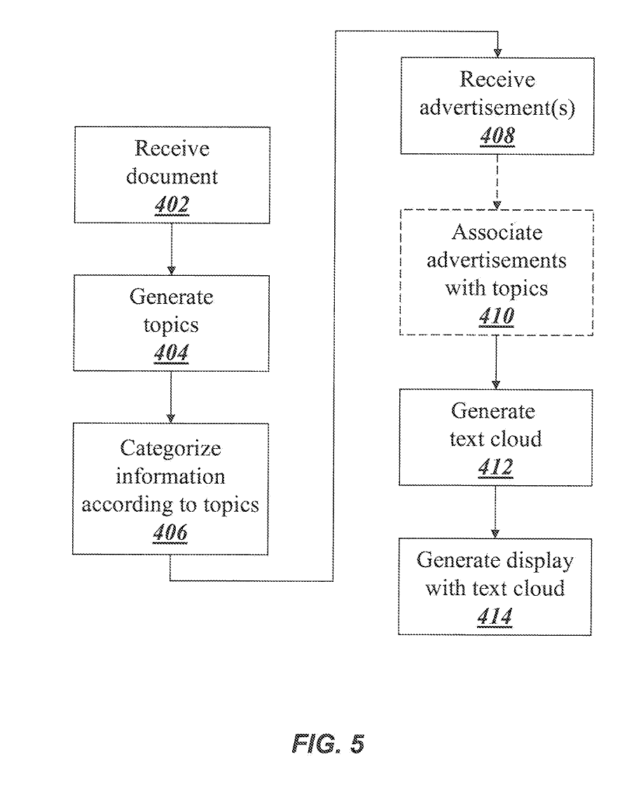

FIG. 5 depicts an illustrative method for generating an example interactive text cloud (such as the interactive text cloud 10 of any of FIGS. 1A through 3C), according to embodiments of the present invention. In particular, the client communications module 102 can receive, from one of the user devices 106, one or more documents or source texts for which an interactive text cloud is to be generated (step 402). For example, the received document(s) or source text(s) can be a website that is being displayed on the user device 106 (e.g., is currently being accessed by a user). Furthermore, the received document(s) or source text(s) can include a text file containing an RSS feed, as described herein. In general, any document or source text can be received by the client communications module 102 in the step 402 of FIG. 5. Furthermore, combinations of different types of documents or source texts can be received at the step 402.

Continuing with FIG. 5, the text cloud generator 110 can generate a plurality of words or topics that are topically associated with a common context (step 404). As examples, the common context can be a common location from which all of the words or topics are derived (e.g., a document, a group of documents, or any other location from which all of the topics are derived), a common theme (e.g., “sports,” “news,” “cooking,” or any other common theme), or any other common context. One of skill in the art will appreciate a wide variety of contexts that can be utilized upon reading the present specification. In illustrative embodiments, the step 404 of generating a plurality of words or topics specifically includes the text cloud generator 110 deriving such a plurality of words or topics from information content of the document(s) or text source(s) that the system 100 receives in the step 402.

In addition, the text cloud generator 110 can categorize and/or associate some or all information content of the received documents (step 406). In particular, some or all the information content can be categorized according to the plurality of topics generated by the system 100 in the step 404. For example, in some embodiments, the text cloud generator 110 can extract a plurality of pieces of information from the received document(s) or source text(s) and associate each of the extracted pieces of information with one or more of the generated words or topics. In general, step 404 and 406 can be performed in the order depicted in FIG. 5, simultaneously, or in a reverse order. For implementations where the received document(s) or source text(s) include a website containing various search results (e.g., as depicted in FIG. 3A), the individual search results 46 can serve as pieces of information content extracted by the text cloud generator 110. In such example implementations, the step 406 of categorizing information content of the received document(s) or source text(s) can include associating each of the search results 46 with one or more of the generated words or topics.

Furthermore, the advertisement engine 112 can retrieve, generate, or otherwise receive one or more advertisements (step 408). The system 100 can be configured to receive advertisements in the step 408 that are topically associated (or alternatively are associated in some other way) with one or more of the generated topics, all of the generated topics, the received document(s) or source text(s), a common context, or some combination thereof. In some embodiments, the received advertisements are automatically selected such that they possess such topical association(s). Alternatively, the received advertisements can be manually selected such that they possess such topical association(s).

For instance, in illustrative embodiments, the text cloud generator 110 selects (e.g., automatically, randomly, etc.) one or more of the words or topics generated in the step 404, and subsequently provides the selected words or topics to the advertisement engine 112 for automatic generation/retrieval of advertisements topically associated therewith. The advertisement engine 112 sends the selected words or topics to one or more third party advertisement servers (not shown in FIG. 4). The advertisement servers and software (e.g., DART, AdStream, AdSense, Microsoft adCenter, Vibrance, Kontera, and the like) can use the selected words or topics to generate, retrieve, etc. one or more advertisements topically associated therewith, and then can send the topically associated advertisements to the system 100. The advertisement engine 112 then receives the one or more topically associated advertisements in the step 408. Alternatively, the advertisement engine 112 can cause an advertisement server (e.g., locally hosted) to generate one or more advertisements that are topically associated with the selected words or topics, and the advertisements generated thereby can be received by the system 100 (e.g., can be received by the text cloud generator 110) from the advertisement server. Still other embodiments are possible and will be appreciated by one of skill in the art upon reading the present specification. All such alternatives are contemplated within the scope of the present invention.

As yet another possibility, the received advertisements can be received such that one or more are topically associated with one or more tags that are associated with the text cloud, the words or topics included therein, or both.

Depending on the particular implementation, received advertisements can be stored in a cache, in the local databases 107, in the remote databases 109, a combination thereof, or can be stored elsewhere, as would be appreciated by one of skill in the art. Optionally, in such embodiments, the system 100 can associate received advertisements with one or more of the topics and/or keywords (step 410). For example, the system 100 can create associations in a database (through links, table data structures, index records, and the like) between stored advertisements and topics stored in the database. In such implementations utilizing storage of received advertisements, the associations that are formed in the step 410 can be used by the system 100 to generate interactive text clouds, e.g., in a more computationally efficient manner.

Proceeding with FIG. 5, the text cloud generator 110 can generate a text cloud (step 414) that includes some or all of the topics generated by the system 100 in step 404. The text cloud further can include some or all of the advertisements received by the system 100 in step 408. The text cloud further can include some or all of the information content (e.g., extracted information content) categorized in step 406 according to the generated words or topics. The text cloud further can include links to web pages containing the information content, e.g., links to the information content categorized in step 406 according to the generated words or topics. Any or all of the text cloud can be included in a visual display of information generated by the GUI generator 108 (step 412), for presentation to users via the user devices 106.

As described previously herein, the generated topics can be topically associated with a common context (e.g., a common location from which the topics are all derived, a common theme, etc.), Furthermore, the generated topics each can be topically associated with information content of one or more documents. In illustrative embodiments, each of the generated topics is topically associated with information content of the received documents. In yet further illustrative embodiments, the generated topics are derived from the information content of the received document(s) or source text(s), as described herein with respect to the step 404 of FIG. 5.

The text cloud in the display generated in step 414 can be interactive, so as to generate an interactive text cloud. For example, in illustrative embodiments, each of the displayed topics is made selectable by users on the user devices 106. Furthermore, selection by a user of one of the displayed topics in the interactive text cloud can initiate further displays of information. The further displays of information generally can include any information content of the document(s) or source text(s) that are received in step 402 or links to such information content. The further displays of information additionally can include one or more of the advertisements received in step 408 that are associated with the selected topic (e.g., as performed by the system 100 in the optional step 410 of FIG. 5).

An example of the method of FIG. 5 will now be described with reference to the example embodiment of FIGS. 3A through 3C. In step 402, the search results web page 42 of FIG. 3A is received by the system 100 from a user device 106. For example, the user device 106 can include a web browser client running the widget, and the user can utilize the widget to send a website (e.g., that is currently being viewed by the user) to the system 100. Once the website is received in the step 402, the system 100 can generate topics in the step 404. The generated words or topics (e.g., which includes the words or topics 12 of the interactive text clouds 10 of FIGS. 3B and 3C) can be derived by the system 100 from the search results web page 42, e.g., by extracting information content of the search results web page 42, parsing the extracted information content, determining word frequencies, etc. In the step 406, each of the search results 46 included in the search results web page 42 can be categorized by the system 100 as being associated with one or more of the words or topics generated in the step 404. In the step 408, the system 100 can receive one or more advertisements associated with one or more of the generated words or topics.

The one or more generated words or topics (from the step 404), the categorized information content (from the step 406), links to the categorized information content, and/or the received advertisements (from the step 408) can be utilized by the system 100 to generate a text cloud in the step 412. in the step 414, the system 100 can generate an interactive display containing some or all of the text cloud generated in the step 412. One example of such a display is depicted by the interactive text cloud 10 of FIG. 3B. The interactive text cloud 10 of FIG. 3B can be accessed by a user operating one of the user devices 106, e.g., through an Internet connection.

Users can be enabled to select or otherwise interact with one, some, or all of the displayed words or topics 12. For example, interaction by a user with a first displayed topic or word 12 from the displayed text cloud 10 (e.g., with the word or topic “tag” 38) can initiate a further display of information, such as the links 40 of FIG. 3C. As described previously herein, the links 40 links to some of the search results 46 (i.e., information content) of the search results web page 42. Furthermore, in illustrative embodiments, the links 40 of FIG. 3C only include links that are categorized in the step 406 to be topically associated with the word or topic “tag” 38. Furthermore, one or more advertisements received by the system 100 in the step 408 that are associated with the word or topic “tag” 38 additionally can be displayed in conjunction with the links 40, and similarly can be displayed as a result of user interaction with the word or topic “tag” 38.

Advertisements generally can include any known advertisement or method of advertising, including as illustrative examples links to company home page websites, links to product websites, sponsored links, any other types of advertising link, higher priority and/or ranking within a list of information, a graphical display, a textual display, a logo, and any other type of advertisement, as described previously herein and understood by one of skill in the art.

While advertisements and further displays of information are described herein with reference to a pop-up panel, it will be understood by one of skill in the art upon reading the present specification that advertisements alternatively or additionally can be displayed in many other forms, including an existing panel (e.g., a separate panel that always appears when the widget is fully loaded and running on a user device 106), as a floating advertisements overlayed on an existing display, and in any other suitable display format. The advertisements can be displayed in conjunction with a plurality of information content of (and/or links to information content of) one or more documents or source texts from which the displayed words or topics are at least in part derived. Accordingly, the system 100 can present both a displayed advertisement and a displayed plurality of information content that are both associated with a common displayed word or topic in an interactive text cloud. Furthermore, both the displayed advertisement and the displayed plurality of information content can be displayed by the system 100 (e.g., in conjunction with one another) as a result of a user interaction (e.g., selection) with the common displayed word or topic.

FIG. 6 illustrates an example computing device 1000 within an illustrative operating environment for implementing illustrative methods and systems of the present invention. The computing device 1000 is merely an illustrative example of a suitable computing environment and in no way limits the scope of the present invention. A “computing device,” as represented by FIG. 6, can include a “workstation,” a “server,” a “laptop,” a “desktop,” a “hand-held device,” a “mobile device,” a “tablet computer,” or any other computing device, as would be understood by those of skill in the art. Given that the computing device 1000 is depicted for illustrative purposes, embodiments of the present invention may utilize any number of computing devices 1000 in any number of different ways in order to implement a single embodiment of the present invention. Accordingly, embodiments of the present invention are not limited to a single computing device 1000, as would be appreciated by one with skill in the art, nor are they limited to a single type of implementation or configuration of the example computing device 1000.

The computing device 1000 can include a bus 1010 that can be coupled to one or more of the following illustrative components, directly or indirectly: a memory 1012, one or more processors 1014, one or more presentation components 1016, input/output ports 1018, input/output components 1020, and a power supply 1024. One of skill in the art will appreciate that the bus 1010 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present invention, and in no way limits the invention.

The computing device 1000 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1000.

The memory 1012 can include computer-storage media in the form of volatile and/or nonvolatile memory. The memory 1012 may be removable, non-removable, or any combination thereof. Exemplary hardware devices are devices such as hard drives, solid-state memory, optical-disc drives, or the like. The computing device 1000 can include one or more processors that read data from components such as the memory 1012, the various I/O components 1016, etc. Presentation component(s) 1016 present data indications to a user or other device. Exemplary presentation components include a display device, speaker, printing component, vibrating component, etc.

The I/O ports 1018 can allow the computing device 1000 to be logically coupled to other devices, such as I/O components 1020. Some of the I/O components 1020 can be built into the computing device 1000. Examples of such I/O components 1020 include a microphone, joystick, recording device, game pad, satellite dish, scanner, printer, wireless device, networking device, or the like.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computer implemented method for interactive advertising, the method comprising:
displaying on a display a context-specific text cloud containing a plurality of displayed topics that are topically associated with a common context; and
displaying an advertisement that is topically associated with one or more displayed topics of the plurality of displayed topics, with the common context of the context-specific text cloud, or both;
wherein the step of displaying an advertisement is initiated by an interaction by a user with a first displayed topic of the plurality of displayed topics.

2. The computer implemented method of claim 1, wherein the interaction with the first displayed topic of the plurality of displayed topics by the user results in displaying information content of a document or source text from which one or more of the plurality of displayed topics are derived.

3. The computer implemented method of claim 1, wherein the plurality of displayed topics are derived from, and topically associated with, information content of a document or source text.

4. The computer implemented method of claim 3, wherein the document or source text comprises a website or a text file containing a feed.

5. The computer implemented method of claim 1, wherein the context-specific text cloud is generated at least in part from one or more documents or source texts.

6. The computer implemented method of claim 1, wherein the advertisement is presented as a link, as a logo, in a graphical form, in a textual form, or a combination thereof.

7. The computer implemented method of claim 1, wherein the advertisement is displayed in conjunction with one or more links associated with the first displayed topic.

8. The computer implemented method of claim 1, wherein the advertisement is displayed in a pop-up panel or in a separate existing panel.

9. The computer implemented method of claim 1, wherein the first displayed topic comprises one of the one or more topics with which the advertisement is topically associated.

10. The computer implemented method of claim 1, wherein the advertisement is topically associated with one or more of the plurality of displayed topics.

11. The computer implemented method of claim 1, wherein the advertisement is topically associated with all of the plurality of displayed topics.

12. The computer implemented method of claim 1, wherein the advertisement is topically associated with the common context of the context-specific text cloud.

13. The computer implemented method of claim 1, wherein the advertisement is topically associated with one or more tags that are associated with the context-specific text cloud.

14. The computer implemented method of claim 1, wherein the advertisement is automatically selected to be topically associated with the one or more displayed topics of the plurality of displayed topics, with the context-specific text cloud, or both.

15. The computer implemented method of claim 1, wherein the advertisement is manually selected to be topically associated with the one or more displayed topics of the plurality of displayed topics, with the context-specific text cloud, or both.

16. The computer implemented method of claim 1, further comprising displaying a pop-up panel comprising one or more links associated with the first displayed topic, wherein the advertisement is presented as one of the one or more links.

17. The computer implemented method of claim 1, further comprising displaying a pop-up panel having one or more links associated with the first displayed topic, wherein the pop-up panel further comprises the advertisement.

18. The computer implemented method of claim 1, wherein the interaction by the user with the first displayed topic comprises the user clicking, hovering over, or selecting the first displayed topic.

19. A machine readable storage medium containing executable instructions stored thereon, wherein execution of the instructions causes a computing device to execute a method, the method comprising:
displaying on a display a context-specific text cloud containing a plurality of displayed topics that are topically associated with a common context; and
displaying an advertisement that is topically associated with one or more displayed topics of the plurality of displayed topics, with the common context of the context-specific text cloud, or both;
wherein the step of displaying an advertisement is initiated by an interaction by a user with a first displayed topic of the plurality of displayed topics.

20. The machine readable storage medium of claim 19, wherein the interaction with the first displayed topic of the plurality of displayed topics by the user results in displaying information content of a document or source text from which one or more of the plurality of displayed topics are derived.

21. The machine readable storage medium of claim 19, wherein the plurality of displayed topics are derived from, and topically associated with, information content of a document or source text.

22. The machine readable storage medium of claim 19, wherein the context-specific text cloud is generated at least in part from one or more documents or source texts.

23. The machine readable storage medium of claim 19, wherein the advertisement is displayed in conjunction with one or more links associated with the first displayed topic.

24. The machine readable storage medium of claim 19, wherein the first displayed topic comprises one of the one or more topics with which the advertisement is topically associated.

25. A computer implemented system, the system comprising:
an advertisement engine for receiving a plurality of advertisements;
a text cloud generator configured to generate a context-specific text cloud, the context-specific text cloud comprising:
a plurality of topics that are topically associated with a common context;
an advertisement of the plurality of advertisements, the advertisement being topically associated with one or more of the plurality of topics, with the common context of the context-specific text cloud, or both;
a client communications module for causing some or all of the context-specific text cloud to be displayed on a user device, wherein the advertisement is configured to be displayed as a result of an interaction by a user with a first topic of the plurality of topics.

26. The computer implemented system of claim 25, wherein the plurality of topics are derived from, and topically associated with, information content of a document or source text.

27. The computer implemented system of claim 25, wherein the context-specific text cloud is generated at least in part from one or more documents or source texts.

28. The computer implemented system of claim 25, wherein the advertisement is caused to be displayed in conjunction With one or more links associated with the first topic.

29. The computer implemented system of claim 25, wherein the first topic comprises one of the one or more topics with which the advertisement is topically associated.
